(19) United States
(12) Patent Application Publication
(10) Pub. No.: US 2026/0300822 A1
(43) Pub. Date: Oct. 1, 2026

(54) COMPUTER-IMPLEMENTED METHOD FOR USING A FEDERATED LEARNING SCHEME WITHIN AN OPEN RADIO ACCESS NETWORK AND A CORRESPONDING SYSTEM

(71) Applicant: NEC Laboratories Europe GmbH, Heidelberg (DE)

(72) Inventors: Lanfranco ZANZI, Heidelberg (DE); Francesco DEVOTI, Heidelberg (DE); Linghang FAN, Heidelberg (DE); Xi LI, Heidelberg (DE)

(21) Appl. No.: 19/475,771

(22) PCT Filed: Oct. 18, 2023
(86) PCT No.: PCT/EP2023/079018

§ 371 Date: Oct. 16, 2025

(30) Foreign Application Priority Data
Apr. 20, 2023 (EP) 23169070.2

(51) Int. Cl. G06N 20/00; H04L 41/16

(52) U.S. Cl. CPC G06N 20/00; H04L 41/16

(57) ABSTRACT

A computer-implemented method for using a federated learning scheme within an Open Radio Access Network, O-RAN, is provided. The method comprising the following steps: providing an O-RAN; deploying a federated learning manager, FLM, in an O-RAN Non-Real-Time RAN Intelligent Controller, Non-RT RIC; coordinating by the FLM an involvement of the Non-RT RIC and an O-RAN Near-Real-Time RAN Intelligent Controller, Near-RT RIC, in at least one federated learning scheme; and executing the at least one federated learning scheme. Further, a corresponding system is provided.

### CROSS REFERENCE TO RELATED APPLICATIONS

This application is a U.S. National Phase application under 35 U.S.C. § 371 of International Application No. PCT/EP2023/079018, filed on Oct. 18, 2023, and claims benefit to European Patent Application No. 23169070.2, filed on Apr. 20, 2023. The International Application was published in English on Oct. 24, 2024 as WO 2024/217710 A1 under PCT Article 21(2).

### FIELD

The present invention relates to a computer-implemented method for using a federated learning scheme within an Open Radio Access Network (O-RAN), and a corresponding system for performing a computer-implemented method for using a federated learning scheme within an O-RAN.

### BACKGROUND

The following abbreviations and terminology, whenever differently stated, are used in this document:

| | |
|---|---|
| 3GPP | 3rd Generation Partnership Project |
| A1 | Interface between Non-RT RIC and Near-RT RIC |
| AI | Artificial Intelligence |
| ACK | Acknowledge |
| NACK | Negative Acknowledge |
| DMS | Deployment Management Services |
| E2 | Interface between Near-RT RIC and underlying |
| | RAN functions, O-CU, O-DU and O-RU |
| EI | Enrichment Information |
| FL | Federated Learning |
| FLM | Federated Learning Manager |
| IID | Independent and Identically Distributed |
| KPI | Key performance indicator |
| ML | Machine Learning |
| Near-RT RIC | O-RAN Near-Real-Time RAN Intelligent Controller |
| Non-RT RIC | O-RAN Non-Real-Time RAN Intelligent Controller |
| O-CU | O-RAN Central Unit |
| O-DU | O-RAN Distributed Unit |
| O-RU | O-RAN Radio Unit |
| O1 | Interface between SMO and O-RAN managed elements |
| OAM | Operations, Administration and Maintenance |
| ORAN | O-RAN ALLIANCE |
| RAN | Radio Access Network |
| RIC | O-RAN RAN Intelligent Controller |
| rApp | Non-RT RIC Applications |
| SMO | Service Management and Orchestration |
| UE | User Equipment |
| xApp | Near-RT RIC Applications |

Corresponding prior art documents are listed as follows:

[TVT2022] On the Specialization of FDRL Agents for Scalable and Distributed 6G RAN Slicing Orchestration, F. Rezazadeh; L. Zanzi; F. Devoti; H. Chergui; X. Costa-Perez; C. Verikoukis, IEEE Transactions on Vehicular Technology, October 2022.

[O-RAN.WG3.RICARCH-v03.00] Alliance, O. R. A. N., 2022, O-RAN Working Group 3: Near-Real-time RAN Intelligent Controller Architecture. O-RAN.WG3.RICARCH-v03.00.

[O-RAN.WG2.AIML] Alliance, O. R. A. N., 2021, O-RAN Working Group 2, AI/ML workflow description and requirements, V01.03.

Further prior art documents:

“OrchestRAN: Network Automation through Orchestrated Intelligence in the Open RAN”, Salvatore D'Oro, Leonardo Bonati, Michele Polese and Tommaso Melodia, Jan. 14, 2022, discloses processing high-level information specified by operators to select the most suitable models from the ML/AI Catalog and the location where they should execute. Further embedding models into containers, and dispatching them to selected nodes is disclosed. However, it does not disclose federated learning in O-RAN.

CN 111242304 B discloses a generic federated learning model deployed in the Non-RT RIC. Network resources are managed in the RAN. Further, it discloses a federated learning-based artificial intelligence model having managing functionalities.

Further, “RIC-O: Efficient placement of a disaggregated and distributed RAN Intelligent Controller with dynamic clustering of radio nodes”, Gabriel M. Almeida, Gustavo Z. Bruno, Alexandre Huff, Matti Hiltunen, Elias P. Duarte Jr., Cristiano B. Both and Kleber V. Cardoso, Jan. 7, 2023, discloses the deployment of Near RT components across the O-cloud, but it does not disclose federated learning.

Most of Machine-Learning approaches require centralizing data in a single location for processing and training purposes. Such approach may become impractical when dealing with large data volumes derived from distributed scenarios, or even open to security issues as data has to be transmitted from the source to the destination process.

Federated Learning (FL) enables collaborative learning and sharing of a prediction model, while keeping all the training process and training data locally on a source device, therefore decoupling the ability to do machine learning from the need to store the data in a single location and enhancing privacy and security as only the output of a local processing, e.g., weights of a ML model, is shared.

FL is also envisioned and desired in O-RAN to enable a more scalable and distributed and secure RAN management by distributing the learning and intelligence to the local nodes and saving the networking resources for transmitting large amounts of data to a central location. There are many different use cases to apply FL in O-RAN. For instance, [TVT2022] proposes the use of FL to manage network slice resources in a federated manner. In particular, a set of decision agents are placed locally at the radio access network nodes and take traffic-aware resource allocation decisions locally. These decision agents are federated to improve the quality of the adopted resource allocation policy according to the long-term dynamics of the underlying traffic. Moreover, the federation strategy adopted is based on defining specialized clusters that enable faster training and communication overhead reduction. However, in order to support such use case and many other different use cases using FL in O-RAN, the standard O-RAN interfaces, as well as both non-RT and near-RT RIC architectures need to support the basic functionality and procedure for the FL. FIG. 1 depicts an example federated learning scheme involving xApps and rApp in the O-RAN domain.

However, the current O-RAN design foresees AI/ML-enabled xApps/rApps but still lacks support to enable federated learning schemes. The current implementation of AI/ML enablers in O-RAN involves the Near-RT RIC and Non-RT RIC entities, as depicted in FIG. 2.

In order to enable the adoption of federated schemes in the O-RAN architecture there is a need to solve the following problems, which have not been addressed in O-RAN:
What new functionalities need to be added to the existing Non-RT RIC architecture to accommodate federated learning?
What procedure is needed for federated learning in ORAN?
What parameters are needed for federated learning in ORAN?
How to enhance the interface between Non-RT RIC and Near-RT RIC to accommodate federated learning?
Which are the criteria to select the Near-RT RIC to participate FL?
What is the procedure to select and notify Near-RT RICs to participate FL?

Additionally, federated learning schemes and their performances are affected and influenced by the following technical aspects:
Heterogeneous training capabilities, e.g., training host in the Non-RT RIC, due to hardware/software constraints and capabilities.
Non IID data distribution which affects Federated Learning procedures.

### SUMMARY

In an embodiment, the present disclosure provides a method for using a federated learning scheme within an Open Radio Access Network (O-RAN). The method includes deploying a federated learning manager (FLM) in an O-RAN Non-Real-Time RAN Intelligent Controller (Non-RT RIC). The FLM coordinates an involvement of the Non-RT RIC and an O-RAN Near-Real-Time RAN Intelligent Controller (Near-RT RIC) in at least one federated learning scheme. The at least one federated learning scheme is executed. The FLM can be a part of or integrated in an Artificial Intelligence (AI)/Machine Learning (ML) function, entity or operation box, and the method can be used for optimizing requests made by network operators or for supporting decision making.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows in a block diagram a federated scheme deployment scenario in an O-RAN;

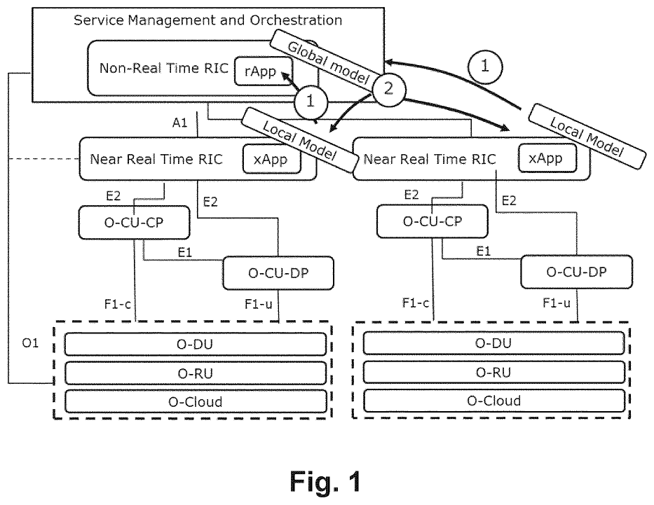

FIG. 2 shows in a block diagram a current implementation of an AI/ML enabler in an O-RAN;

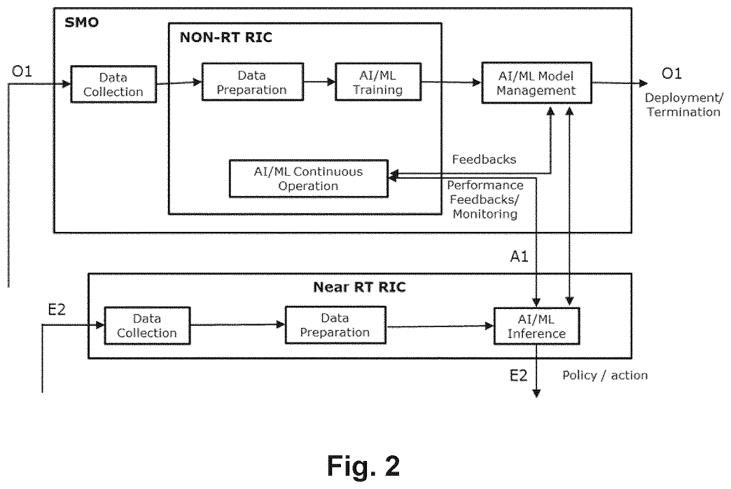

FIG. 3 shows in a block diagram an embodiment of a FLM to enable FL in an O-RAN; and

FIG. 4 in a diagram an embodiment of a registration and deployment procedure.

### DETAILED DESCRIPTION

Embodiments of the present disclosure improve and further develop a computer-implemented method for using a federated learning scheme within an O-RAN and a corresponding system for providing a particular efficient use or execution of the federated learning scheme by simple and efficient means.

An embodiment of the present disclosure includes a computer-implemented method for using a federated learning scheme within an Open Radio Access Network, O-RAN, comprising the following steps:
deploying a federated learning manager, FLM, in an O-RAN Non-Real-Time RAN Intelligent Controller, Non-RT RIC;
coordinating by the FLM an involvement of the Non-RT RIC and an O-RAN Near-Real-Time RAN Intelligent Controller, Near-RT RIC, in at least one federated learning scheme; and
executing the at least one federated learning scheme.

An embodiment of the present disclosure includes a system for performing a computer-implemented method for using a federated learning scheme within an O-RAN, comprising:
a federated learning manager, FLM, in an O-RAN Non-Real-Time RAN Intelligent Controller, Non-RT RIC, wherein the FLM comprises coordinating means for coordinating an involvement of the Non-RT RIC and an O-RAN Near-Real-Time RAN Intelligent Controller, Near-RT RIC, in at least one federated learning scheme; and
executing means for executing the at least one federated learning scheme.

According to embodiments of the present disclosure it has been recognized that it is possible to provide a particular efficient use of the federated learning scheme by simple and efficient means by providing a federated learning manager (FLM) in an O-RAN Non-Real-Time RAN Intelligent Controller (Non-RT RIC) of the O-RAN. Concretely and in a particularly smart way, the FLM comprises coordinating means for coordinating an involvement of the Non-RT RIC and an O-RAN Near-Real-Time RAN Intelligent Controller (Near-RT RIC) in at least one federated learning scheme. The use or installation of such an FLM provides coordination of all necessary interactions between multiple components of the O-RAN. The FLM can operate as a coordination point regarding different tasks in the execution of a federated learning scheme. As a result a federated learning scheme can be executed with high efficiency.

Thus, the method and system of the present disclosure provide a particular efficient use or execution of the federated learning scheme by simple and efficient means.

According to an embodiment of the present disclosure, the coordinating step can comprise the coordination of a registration, instantiation, deployment and/or run-time execution or operation of the at least one federated learning scheme. During this step the FLM can act as a coordination point for providing a particular efficient execution of a federated learning scheme.

In an embodiment of the present disclosure, the coordinating step or the coordination can comprise a computing capability estimation, a training profile definition, a placement strategy definition and/or an agent selection and mapping, wherein preferably the FLM can support a re-selection of at least one agent or a dynamic re-selection of at least one agent. This can provide a very efficient use and execution of a federated learning scheme in the O-RAN.

According to an embodiment of the present disclosure, the involvement of the Non-RT RIC and the Near-RT RIC can comprise the involvement of at least one xApp and at least one rApp. This involvement can provide the suitable and effective use and operation of at least one xApp and at least one rApp.

In an embodiment of the present disclosure, the involvement of the at least one xApp and the at least one rApp can comprise a model exchange between the at least one xApp and the at least one rApp. On the basis of such a model exchange a very effective use of the at least one xApp and at least one rApp can be provided.

According to an embodiment of the present disclosure, the coordinating step comprises deciding a placement and/or instantiation of at least one xApp, preferably according to a higher-level information and/or a defined placement strategy. As a result a very flexible and effective execution of a federated learning scheme can be provided.

According to an embodiment of the present disclosure, the xApp, xApps, agent or agents, participating in the at least one federated learning scheme can change according to at least one selection criterion. This selection criterion can be defined for providing an effective execution of a federated learning scheme in the O-RAN.

In an embodiment of the present disclosure, the coordinating step can comprise selecting at least one Near-RT RIC or target Near-RT RIC, based on a topology information and/or a system load. In an embodiment of the present disclosure, the coordinating step can comprise selecting a xApp and/or rApp placement, based on the outcome of at least one of the previous method steps. In an embodiment of the present disclosure, the coordinating step can comprise onboarding and deploying of at least one xApp in at least one Near-RT RIC or target Near-RT RIC. One or more of these embodiments of the coordinating step can result in a very suitable and effective use or execution of a federated learning scheme in the O-RAN.

According to an embodiment of the present disclosure, the coordinating step can be performed by the FLM upon a receipt of a request of a network user or network operator, preferably via a SMO, or upon a receipt of a request by a third party. As a result, an individual and definable start of the coordinating step can be provided for adaptation to individual requirements before of the O-RAN.

In an embodiment of the present disclosure, the coordinating step can comprise performing an initial training profile estimation to evaluate its requirement or requirements. This can result in a very efficient use of resources of an underlying network or system.

In an embodiment of the present disclosure, the coordinating step can comprise performing a capability estimation procedure to determine available resources or an available set of resources, based on a current or future availability and/or a current or future system load, wherein preferably the FLM can query a training host to estimate the available resources or the available set of resources. This can also result in a very efficient use of resources of an underlying network or system for providing a high efficient use of the execution of a federated learning scheme in the O-RAN.

In an embodiment of the present disclosure, the coordinating step and/or the executing of the at least one federated learning scheme can comprise performing a collection, a validation and/or an update of at least one preferably local model in a federated manner. This embodiment can result in a very suitable and effective use or execution of a federated learning scheme in the O-RAN.

According to an embodiment of the present disclosure, at least one global model update can be returned to at least one Near-RT RIC or target Near-RT RIC. This can also result in a very efficient use on the execution of a federated learning scheme in the O-RAN.

In an embodiment of the present disclosure, the FLM can be a part of or can be integrated in an Artificial Intelligence/Machine Learning (AI/ML) function, entity or operation box. This provides a very smart integration of the FLM into a system or network.

Advantages and aspects of embodiments of the present disclosure are summarized as follows:

According to embodiments an FLM can be deployed in the Non-RT RIC, enabling model exchange between xApps and rApps and performing the following steps:
1. Processing an incoming request and performing an initial training profile estimation to evaluate its requirements.
2. Performing a capability estimation procedure to determine the available set of resources, based on current availability and system load.
3. Deciding a placement and instantiation of xApps according to higher level information and a defined placement strategy.
4. Selecting target Near-RT RICs based on topology information and system load and selecting an xApp/rApp placement based on an outcome of the previous steps.
5. Upon successful selection, onboarding and/or deploying the xApps in the target Near-RT RICs.
6. Exchanging models between Near-RT RICS and Non-RT RICs.
7. Performing collection, validation and update of local models in a federated manner.
8. Returning global model updates to target Near-RT RICs.

Further advantages of embodiments of the present disclosure are as follows:
1) Embodiments can comprise a Federated Learning Manager (FLM) inside the non-RT RIC to coordinate the instantiation, deployment, and run-time execution of federated learning schemes involving multiple xApps/rApps in the O-RAN framework, the FLM comprising one or more of the following main functionalities:
   a. Capabilities Estimation
   b. Training Profile Definition
   c. Placement Strategy Definition
   d. Agent Selection and mapping
2) Embodiments can comprise a novel deployment procedure for a deployment of Federated Learning models upon a request or requests of a SMO or even third-party entities, interacting with both Near-RT and Non-RT RIC entities, and a registration procedure for the corresponding training profiles between the Non-RT RIC and Near-RT RIC.

Thus, embodiments of the present disclosure can enable federated learning in a provided O-RAN.

An embodiment of the present disclosure can provide a method and a system to enable, setup and manage federated learning schemes within an O-RAN framework and architecture.

Thus, an embodiment of the present disclosure can provide a Federated Learning Manager and procedures to enable the deployment and execution of federated learning schemes in O-RAN.

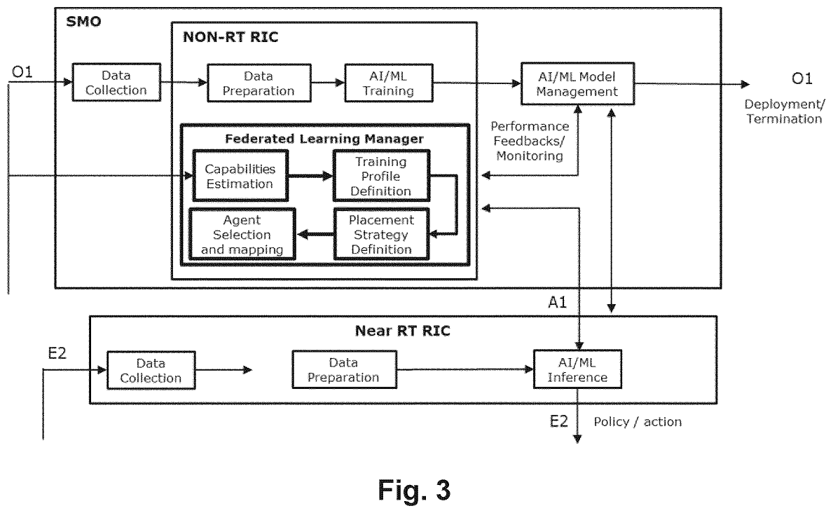

Embodiments of the present disclosure provide an architectural extension in O-RAN that enables FL. FIG. 3 shows in a block diagram an embodiment implementation by means of an extension of the O-RAN Non-RT RIC architecture to enable the federated learning operation in O-RAN. The present disclosure introduces a novel functional entity—Federated Learning Manager (FLM)—inside the Non-RT RIC architecture. Required interactions to the rest of the building blocks within the Non-RT RIC as well as towards the Near-RT RIC and the SMO can be provided by the FLM, to enable federated learning in O-RAN upon the requests of network operators via the SMO or by third party players. In addition, required procedures for the registration, deployment, and/or operation of the federated learning are defined. They are described in the following embodiments:
Embodiment 1: Federated Learning Manager
Embodiment 2: Deployment and Registration procedure for Training Profile

### Embodiment 1: Federated Learning Manager

In the following, the novel functionalities and procedures as to enable the adoption of federated learning schemes in the context of O-RAN are explained.

The FLM is a novel entity that acts as a main coordination point between the multiple entities involved in the federation, e.g., coordinating data exchange, validating models through registration, etc. The FLM is a logical function and can be a part of AI/ML functions, which provides AI/ML services.

As depicted in FIG. 3, the FLM is a software-based component instantiated in the Non-RT RIC premises, e.g., within the AI/ML Continuous operation box, where it can gain access to platform-level information, such as topology and computing load, as well as to Near-RT RIC functionalities and feedbacks.

The FLM according to this embodiment is composed of one or more of the following main functionalities:
1. Capabilities Estimation
2. Training Profile Definition
3. Placement Strategy Definition
4. Agent Selection and mapping

### Capabilities Estimation

The O-RAN framework has been designed to natively support the adoption of ML-based model and logics to derive optimal control policies.

In this context, the so-called Training Host supports the computing process required to train machine learning-based models by exploiting dedicated hardware resources, e.g., GPUs. Upon receiving a new deployment_request or model training_request, the Federated Learning Manager queries the training host to estimate the computing resource availability, before triggering the training of model or the deployment of the specific rApps. This step also includes an estimation of networking resource capabilities as to guarantee optional latency constraints brought by the specific deployment_request or training_request.

The deployment_request or training_request message may include one or more of the following non-exhaustive parameters:
Request ID
rAPP ID
Existing xApps IDs, or number of xApps to be deployed
Input data List, e.g., measurement data, monitoring metrics for training
Kind of local ML model running in the xApp
Output data List, e.g., information that will be shared during the federation steps
Configuration of ML model training
Federated Learning hyperparameters, e.g., periodicity, federation strategy, latency requirements, etc.
Evaluate criteria of model training

Different names can be used for above parameters to serve the same and similar purpose.

### Training Profile Definition

The distributed nature of the RAN domain well matches with federated learning schemes in which ML-based local agents train local model instances based on local monitoring or measurement data, and only share the output of this process to a centralized entity in charge of collecting and aggregate the local model updates aiming to build a global and general knowledge from the environment. Nevertheless, the local state of an agent may include multiple monitoring or measurement metrics not necessarily available in a specific location and moving data may come at a non-negligible cost. Moreover, depending on the specific ML-model and federation strategy, the computing load required to train and subsequently test/execute the solution may vary. To this aim, based on the model details description contained in the deployment_request or training_request message, the Federated Learning Manager can derive a Training Profile of the requested federated learning scheme.

The training profile may include one or more of the following non-exhaustive parameters:
Traffic condition
Radio Access Network topology
xApp deployment location
Resource allocation
Runtime Context in the form of metadata, e.g., required software libraries, etc.
Energy consumption
Hardware used in the model training
Status of O-Cloud resource during model training

### Placement Strategy Definition

xApps belonging to federated learning schemes must perform local processing of monitoring KPIs, measurement data, and training of ML-based models on the same data. For these reasons, an accurate placement and instantiation of xApps is required accounting for, among the others, one or more of:
Fast Access to necessary data
Current Load in the system
Estimated training capabilities
Derived Training Profile
Specific O-RAN topology

The Federated Learning Manager can consider such aspects and derive optimal policies to instantiate/deploy the target number of xApps in the most suitable location.

### Agent Selection and Mapping

Federated learning schemes often assume Independent and Identically Distributed, IID, data, where Independent indicates that subsequent samples are not dependent to each other, and Identically Distributed means that all samples are taken from the same probability distribution in absence of fluctuations and/or embedded trends. Such properties are beneficial to avoid bias in the federation step, especially when dealing with distributed gradient updates.

However, most realistic scenarios present non-IID data, and this is particularly true in RAN domains where monitoring KPIs and time-series are often correlated in space and time to each other.

To mitigate this, the Federated Learning Manager can support the dynamic re-selection of agents, e.g., xApps, performing the federation procedure, according to e.g., platform aware logic derived from the deployment_request or training request messages.

### Embodiment 2: Registration and Deployment Procedure

It is assumed that a 3^{rd}-party is already authenticated with the O-RAN framework and allowed to communicate to the SMO, moreover it is assumed that the training profile of the target application has been already registered as per Embodiment 2.

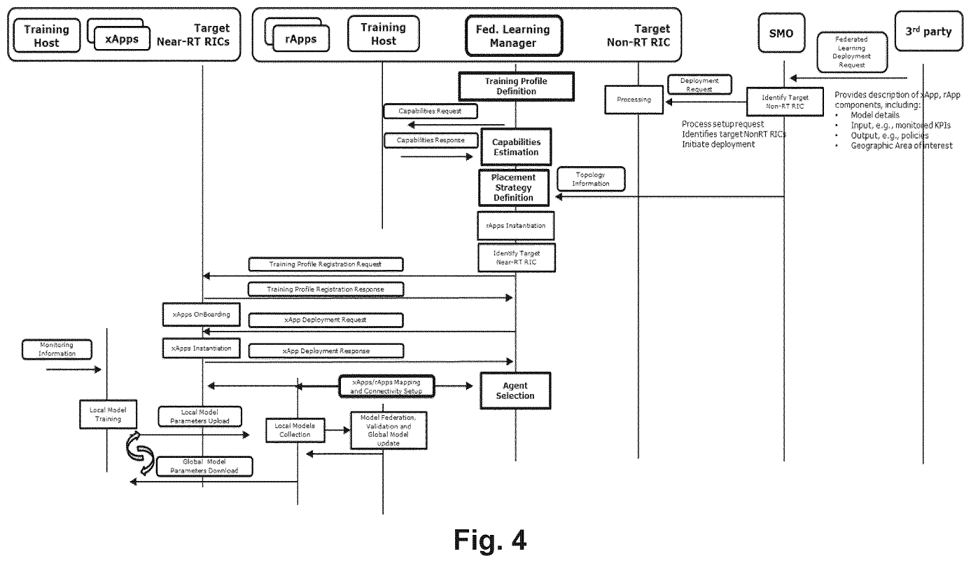

In FIG. 4 it is proposed an exemplary deployment procedure for 3^{rd}-party entities to request the deployment of Federated Learning schemes into the O-RAN framework.

The following steps are possible:
1. The 3^{rd} party initiates the procedure by providing a deployment_request message. The message may include one or more of the following non exhaustive set of parameters:
   Model and or application details
   Input information description
   Output description, e.g., policy
   Type of deployment e.g., xApp or rApp
   Target area of deployment
2. The SMO receives and processes the message, selecting a target Non-RT RIC, e.g., based on geographical constraints, which will oversee the following management and operational steps, including e.g., enforcement of re-configurations.

This step includes Verification: the SMO reads the content of deployment_request message, verifying its completeness and integrity. If data is missing or is corrupted a deny request message is sent back to the 3^{rd} party and the procedure is aborted otherwise it proceeds to the next step.
3. Selection of target Non-RT RICs: the SMO selects the target Non-RT RICs suitable for hosting the new Federated Manager instance, FLM. The selection is made by processing the information in the deployment_request, and could be made including information on the current O-RAN network status, e.g., network load distribution, etc.
   Forward: the deployment_request is forwarded to the selected Non-RT RICs

The next steps can be done in parallel over the pool of selected Non-RT RICs:
4. The Non-RT RIC, more precisely its Federated Learning Manger instance, derives the training profile for the incoming request.
5. The Non-RT RIC queries its Training Host to obtain information regarding the availability of computing resources before initiating the deployment of required rApp(s).
6. The Non-RT RIC gets topology information of the current O-RAN deployment, and derives a placement strategy based, e.g., on requirements and/or current load in the system. The topology information can be retrieved for example from the SMO, i.e., Topology Exposure and Inventory Management, TE&IV, service.
7. The Non-RT RIC instantiates the rApp instance(s) related him to the incoming deployment_request. The Federated Learning Model running in the rApp is registered, e.g., by means of the AI/ML model management functions.
8. Based on the outcome of step 6, the Non-RT RIC derives the set of target Near-RT RIC—note that they may be multiple—and forwards a training_profile_registration_request associated to the incoming deployment_request. The message includes one or more of the following non exhaustive set of parameters:
   Type of model
   Input set of parameters
   Output set of parameters
   Evaluation Criteria
9. Upon receiving the training_profile_registration_request message, the target Near-RT RICs process the request and reply with a training_profile_registration_response. The response contains a positive or negative ack to the registration request based on the status of the Near-RT RIC, i.e., traffic and computation load, etc.
   Note that the response may follow a query to the local training host at the Near-RT RIC, if present, to estimate its computing capabilities. A local training host will be used to perform training of local ML models in relation to the federated scheme. In an embodiment of the present disclosure, such training can be off-loaded to e.g., the Non-RT RIC training host. Additional costs, e.g., in terms of communication latency, should be considered in this case.
10. xApps Onboarding: the Near-RT RICs positively acknowledging the training_profile_registration_request initiates the corresponding xApps instances and sets up the required communication. Note that the xApp instance can be selected following the A1 Policy Setup procedure described in [O-RAN.WG3.RICARCH-v03.00].
11. The federated learning manager processes the set of training_profile_registration_response received and sends an xApp_Deployment_Request message to the Near-RT RICs positively acknowledging the training profile registration request. The deployed xApp will take part to the federation.
12. The Near-RT RICs reply with xApp_Deployment_Response message, this message can be an AKC or NACK depending on the successful finalization of the xApp deployment.
13. The xApps subscribe to the required monitoring metrics and start to train their local model. The training procedure could be off-loaded and performed by means of a local training host at the Near-RT RIC, if available.
14. According to e.g., specific Federated Learning hyperparameters characterizing the federated epoch duration and/or periodicity, the xApp upload its partially trained instance of a machine learning model, or related parameters like e.g., gradient updates, to the reference rApp.
15. The reference rApp collects multiple local models/updates, and according to specific federation strategies, processes them obtaining a global version of the model. The processing task can be offloaded to a local training host at the Non-RT RIC, if available.
16. Optional step. The set of xApps—or agents—participating in the federation step can change dynamically according to heterogeneous selection criteria, e.g., traffic distribution [TVT2022]. The selection can occur at xApp or Non-RT level. Nevertheless, the selection entity needs to update the Federated Learning Manager, or existing AI/ML model management functions to keep track of the evolution of the schema.

Different names can be used for above deployment_request message to serve the same and similar purpose.

Many modifications and other embodiments of the present disclosure set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for using a federated learning scheme within an Open Radio Access Network (O-RAN), comprising the following steps:
deploying a federated learning manager (FLM) in an O-RAN Non-Real-Time RAN Intelligent Controller (Non-RT RIC);
coordinating, by the FLM, an involvement of the Non-RT RIC and an O-RAN Near-Real-Time RAN Intelligent Controller (Near-RT RIC) in at least one federated learning scheme; and
executing the at least one federated learning scheme.

2. The method according to claim 1, wherein the coordinating step comprises coordination of a registration, instantiation, deployment and/or run-time execution or operation of the at least one federated learning scheme.

3. The method according to claim 2, wherein the coordinating step comprises a computing capability estimation, a training profile definition, a placement strategy definition and/or an agent selection and mapping.

4. The method according to claim 1, wherein the involvement of the Non-RT RIC and the Near-RT RIC comprises the involvement of at least one xApp and at least one rApp.

5. The method according to claim 4, wherein the involvement of the at least one xApp and the at least one rApp comprises a model exchange between the at least one xApp and the at least one rApp.

6. The method according to claim 4, wherein the coordinating step comprises deciding a placement and/or instantiation of the at least one xApp.

7. The method according to claim 4, wherein the at least one xApp, xApps, agent or agents, participating in the at least one federated learning scheme change according to at least one selection criterion.

8. The method according to claim 1, wherein the coordinating step comprises at least one of:
selecting at least one Near-RT RIC or target Near-RT RIC; based on a topology information and/or a system load;
selecting an xApp and/or an rApp placement based on an outcome of a previous step of the method; or
onboarding and deploying of at least one xApp in the at least one Near-RT RIC or the target Near-RT RIC.

9. The method according to claim 1, wherein the coordinating step is performed by the FLM upon a receipt of a request of a network user or network operator, or upon a receipt of a request by a third party.

10. The method according to claim 9, wherein the coordinating step comprises performing an initial training profile estimation to evaluate one or more requirements of the request.

11. The method according to claim 1, wherein the coordinating step comprises performing a capability estimation procedure to determine available resources or an available set of resources, based on a current or future availability and/or a current or future system load.

12. The method according to claim 1, wherein the coordinating step and/or the executing of the at least one federated learning scheme comprises performing a collection, a validation and/or an update of at least one local model in a federated manner.

13. The method according to claim 12, wherein at least one global model update is returned to at least one Near-RT RIC or target Near-RT RIC.

14. The method according to claim 1, wherein the FLM is a part of or is integrated in an Artificial Intelligence/Machine Learning (AI/ML) function, entity or operation box.

15. A system for performing a computer-implemented method for using a federated learning scheme within an Open Radio Access Network (O-RAN) according to claim 1, the system comprising:
a federated learning manager (FLM) in an O-RAN Non-Real-Time RAN Intelligent Controller (Non-RT RIC), wherein the FLM is configured to coordinate an involvement of the Non-RT RIC and an O-RAN Near-Real-Time RAN Intelligent Controller (Near-RT RIC) in at least one federated learning scheme; and
at least one processor configured to execute the at least one federated learning scheme.

16. The method according to claim 3, wherein the coordinating step comprises the FLM supporting a re-selection of at least one agent or a dynamic re-selection of the at least one agent.

17. The method according to claim 4, wherein the coordinating step comprises deciding a placement and/or instantiation of the at least one xApp according to a higher-level information and/or a defined placement strategy.

18. The method according to claim 9, wherein the coordinating step is performed by the FLM upon the receipt of the request of the network user or the network operator via Service Management and Orchestration (SMO).

19. The method according to claim 11, wherein the FLM queries a training host to estimate the available resources or the available set of resources.

20. The method according to claim 1, wherein the FLM is instantiated within an Artificial Intelligence/Machine Learning (AI/ML) continuous operation box for accessing platform-level information and optimizing requests made by network operators.
